(19) United States
(12) Patent Application Publication
(10) Pub. No.: US 2008/0198511 A1
(43) Pub. Date: Aug. 21, 2008

(54) Suspension for a hard disk drive microactuator

(76) Inventors: Toshiki Hirano, San Jose, CA (US); Haruhide Takahashi, Kanagawa (JP)

Correspondence Address: HITACHI C/O WAGNER BLECHER LLP, 123 WESTRIDGE DRIVE, WATSONVILLE, CA, 95076, US

(21) Appl. No.: 11/708,938

(22) Filed: Feb. 20, 2007

(51) Int. Cl. G11B 5/56

(52) U.S. Cl. 360/294.4

(57) ABSTRACT

A disk drive flexure is provided. The disk drive flexure includes a first surface for coupling with a microactuator, the microactuator comprising a moving portion and a stationary portion wherein the moving portion and the stationary portion are integrated within a substrate and wherein the stationary portion is coupled to the first surface by an adhesive. The disk drive flexure further includes a spacer portion for maintaining a distance between the microactuator and the flexure such that the moving portion does not contact the flexure and wherein the spacer portion prevents the adhesive from contacting the moving portion of the microactuator.

### TECHNICAL FIELD

The invention relates to the field of hard disk drive development.

### BACKGROUND ART

Direct access storage devices (DASD) have become part of everyday life, and as such, expectations and demands continually increase for greater speed for manipulating and for holding larger amounts of data. To meet these demands for increased performance, the mechano-electrical assembly in a DASD device, specifically the Hard Disk Drive (HDD) has evolved to meet these demands.

Advances in magnetic recording heads as well as the disk media have allowed more data to be stored on a disk's recording surface. The ability of an HDD to access this data quickly is largely a function of the performance of the mechanical components of the HDD. Once this data is accessed, the ability of an HDD to read and write this data quickly is a primarily a function of the electrical components of the HDD.

A computer storage system may include a magnetic hard disk(s) or drive(s) within an outer housing or base containing a spindle motor assembly having a central drive hub that rotates the disk. An actuator includes a plurality of parallel actuator arms in the form of a comb that is movably or pivotally mounted to the base about a pivot assembly. A controller is also mounted to the base for selectively moving the comb of arms relative to the disk.

Each actuator arm has extending from it at least one cantilevered electrical lead suspension. A magnetic read/write transducer or head is mounted on a slider and secured to a flexure that is flexibly mounted to each suspension. The read/write heads magnetically read data from and/or magnetically write data to the disk. The level of integration called the head gimbal assembly (HGA) is the head and the slider, which are mounted on the suspension. The slider is usually bonded to the end of the suspension.

A suspension has a spring-like quality, which biases or presses the air-bearing surface of the slider against the disk to cause the slider to fly at a precise distance from the disk. Movement of the actuator by the controller causes the head gimbal assemblies to move along radial arcs across tracks on the disk until the heads settle on their set target tracks. The head gimbal assemblies operate in and move in unison with one another or use multiple independent actuators wherein the arms can move independently of one another.

To allow more data to be stored on the surface of the disk, more data tracks must be stored more closely together. The quantity of data tracks recorded on the surface of the disk is determined partly by how well the read/write head on the slider can be positioned and made stable over a desired data track. Vibration or unwanted relative motion between the slider and surface of disk will affect the quantity of data recorded on the surface of the disk.

To mitigate unwanted relative motion between the slider and the surface of the disk, HDD manufacturers are beginning to configure HDDs with a secondary actuator in close proximity to the slider. A secondary actuator of this nature is generally referred to as a microactuator because it typically has a very small actuation stroke length, typically plus and minus 1 micron. A microactuator typically allows faster response to relative motion between the slider and the surface of the disk as opposed to moving the entire structure of actuator assembly.

### SUMMARY OF THE INVENTION

A disk drive flexure is provided. The disk drive flexure includes a first surface for coupling with a microactuator, the microactuator comprising a moving portion and a stationary portion wherein the moving portion and the stationary portion are integrated within a substrate and wherein the stationary portion is coupled to the first surface by an adhesive. The disk drive flexure further includes a spacer portion for maintaining a distance between the microactuator and the flexure such that the moving portion does not contact the flexure and wherein the spacer portion prevents the adhesive from contacting the moving portion of the microactuator.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is plan view of an exemplary HDD in accordance with an embodiment of the present invention.

FIG. 2 is an inverted isometric view an exemplary slider assembly in accordance with an embodiment of the present invention.

FIG. 3 is an isometric view of an exemplary microactuator assembly in accordance with an embodiment of the present invention.

FIG. 4 is a plan view of an exemplary substrate of a microactuator in accordance with an embodiment of the present invention.

FIG. 5 is an illustration of an exemplary disk drive suspension including an exemplary spacer for maintaining a distance between the suspension and a microactuator in accordance with an embodiment of the present invention.

FIG. 6 is a side view of an exemplary disk drive flexure, disk drive suspension and spacer prior to bonding in accordance with an embodiment of the present invention.

FIG. 7 is a side view of an exemplary disk drive flexure, disk drive suspension and spacer after bonding in accordance with an embodiment of the present invention

FIG. 8 is a cross section of an exemplary suspension comprising a flexure with an integrated spacer in accordance with embodiments of the present invention.

### DETAILED DESCRIPTION

Reference will now be made in detail to embodiment(s) of the present invention. While the invention will be described in conjunction with the embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, and components have not been described in detail as not to unnecessarily obscure aspects of the present invention.

The discussion will begin with an overview of a hard disk drive and components connected within. The discussion will then focus on embodiments of the invention that provide a spacer between a suspension and a microactuator. The discussion will then focus on embodiments of this invention that provide a stand alone spacer, a spacer integrated with the suspension and a spacer integrated within a microactuator.

Although embodiments of the present invention will be described in conjunction with a substrate of a microactuator, it is understood that the embodiments described herein are useful outside of the art of microactuators, such as devices requiring high frequency transmission between two devices that have relative motion. The utilization of the substrate of a microactuator is only one embodiment and is provided herein merely for purposes of brevity and clarity.

### Overview

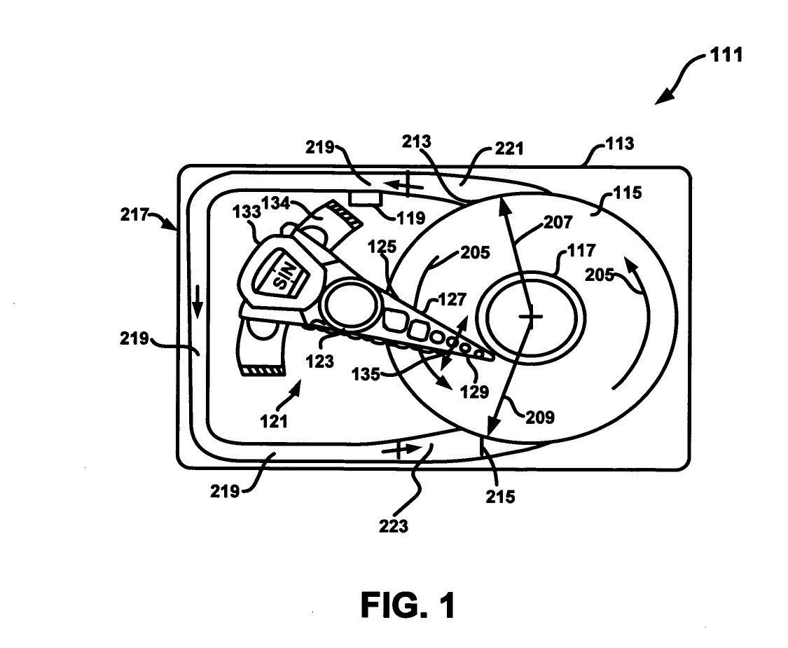

With reference now to FIG. 1, a schematic drawing of one embodiment of an information storage system comprising a magnetic hard disk file or drive 111 for a computer system is shown. Drive 111 has an outer housing or base 113 containing a disk pack having at least one media or magnetic disk 115. A spindle motor assembly having a central drive hub 117 rotates the disk or disks 115. An actuator 121 comprises a plurality of parallel actuator arms 125 (one shown) in the form of a comb that is movably or pivotally mounted to base 113 about a pivot assembly 123. A controller 119 is also mounted to base 113 for selectively moving the comb of arms 125 relative to disk 115.

In the embodiment shown, each arm 125 has extending from it at least one cantilevered electrical lead suspension (ELS) 127 (load beam removed). It should be understood that ELS 127 may be, in one embodiment, an integrated lead suspension (ILS) that is formed by a subtractive process. In another embodiment, ELS 127 may be formed by an additive process, such as a Circuit Integrated Suspension (CIS). In yet another embodiment, ELS 127 may be a Flex-On Suspension (FOS) attached to base metal or it may be a Flex Gimbal Suspension Assembly (FGSA) that is attached to a base metal layer. The ELS may be any form of lead suspension that can be used in a Data Access Storage Device, such as a HDD. A magnetic read/write transducer or head is mounted on a slider 129 and secured to a flexure that is flexibly mounted to each ELS 127. The read/write heads magnetically read data from and/or magnetically write data to disk 115. The level of integration called the head gimbal assembly is the head and the slider 129, which are mounted on suspension 127. The slider 129 is usually bonded to the end of ELS 127

ELS 127 has a spring-like quality, which biases or presses the air-bearing surface of the slider 129 against the disk 115 to cause the slider 129 to fly at a precise distance from the disk. The ELS 127 has a hinge area that provides for the spring-like quality, and a flexing interconnect (or flexing interconnect) that supports read and write traces through the hinge area. A voice coil 133, free to move within a conventional voice coil motor magnet assembly 134 (top pole not shown), is also mounted to arms 125 opposite the head gimbal assemblies. Movement of the actuator 121 (indicated by arrow 135) by controller 119 causes the head gimbal assemblies to move along radial arcs across tracks on the disk 115 until the heads settle on their set target tracks. The head gimbal assemblies operate in a conventional manner and move in unison with one another, unless drive 111 uses multiple independent actuators (not shown) wherein the arms can move independently of one another.

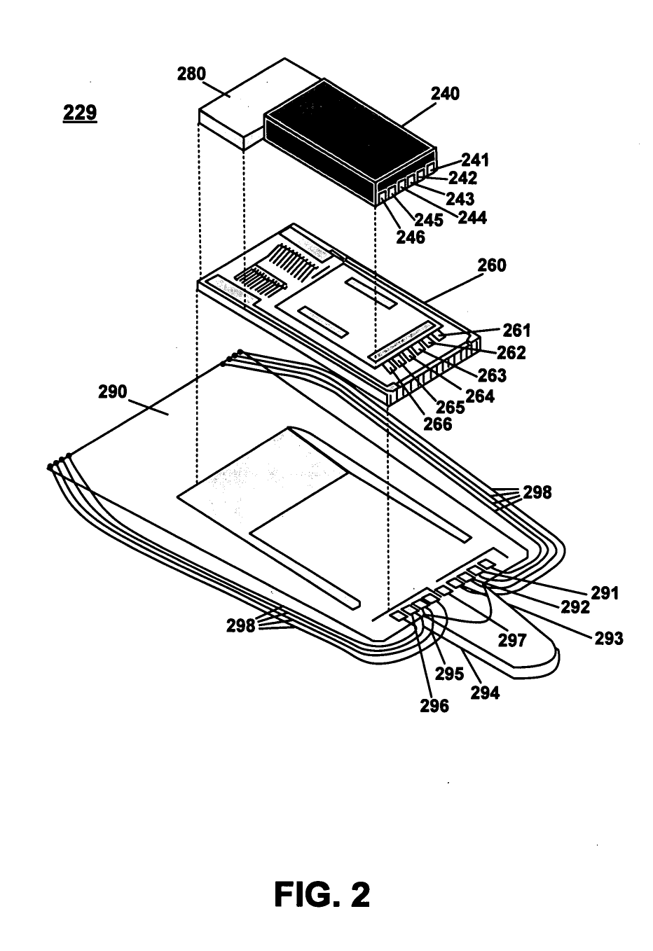

FIG. 2 is an inverted isometric view of an HGA 229, which is an assembly of slider 129 and an ELS 127 of FIG. 1. HGA 229 shown to include a piezoelectric type (PZT) ceramic 280, a read/write transducer (magnetic head) 240, a microactuator 260, and a suspension 290, each of which are intercommunicatively coupleable and within which microactuator 260 is interposed between magnetic head 240 and suspension 290.

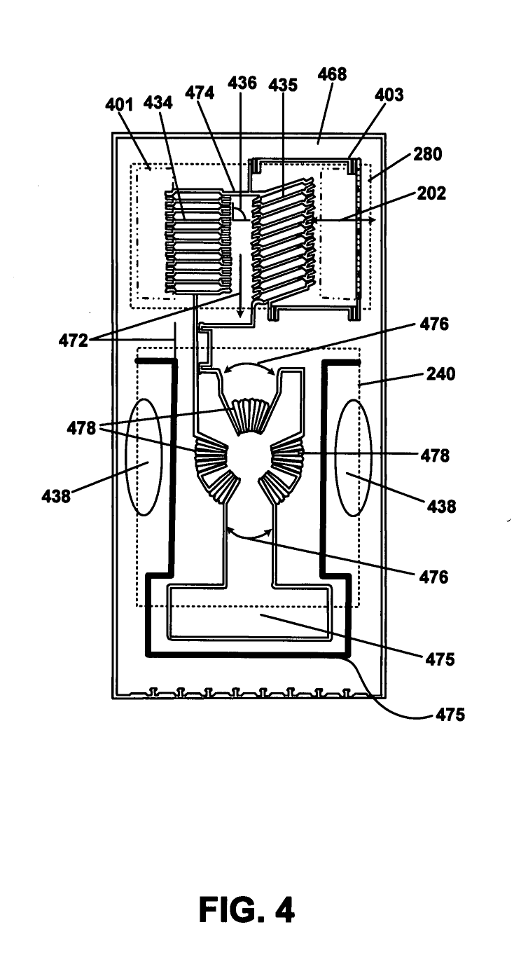

In one embodiment of the invention, a space or gap is maintained between the suspension 290 and the microactuator 260. The space is necessary to prevent the moving portions of the microactuator from contacting the suspension, which could reduce the performance of the microactuator 260. The space also aids in the attachment of the microactuator to the suspension 260. In one embodiment of the invention, a spacer is used to maintain the desired distance between the microactuator and the suspension. Descriptions of the various embodiments of the spacer are provided in conjunction with FIGS. 4-8 below.

In the embodiment shown, microactuator 260 includes a plurality of component data interconnects or data transmission lines terminating in slider bonding pads 261, 262, 263, 264, 265 and 266, and magnetic head 240 includes a plurality of data transmission lines terminating in transducer bonding pads 241, 242, 243, 244, 245 and 246. It is noted that each data communication line associated with each transducer bonding pad 241-246 or slider bonding pad 261-266 may terminate within and/or couple with another line within and/or provide an additional externally accessible communicative connection for the component in which it is disposed. It is further noted that slider bonding pad 261 of microactuator 260 is associated with transducer bonding pad 241 of magnetic head 240; slider bonding pad 262 is associated with transducer bonding pad 242, and so on.

Although six bonding pads are shown on microactuator 260 of FIG. 2, it is noted that microactuator 260 may be configured to have a greater or lesser number of bonding pads.

Although embodiments of the present invention are described in the context of a microactuator in an information storage system, it should be understood that embodiments may apply to devices utilizing an electrical interconnect. For example, embodiments of the present invention may apply to rigid printed circuit boards. More specifically, embodiments of the present invention may be used in printed circuit boards that are used for high speed signal processing. Embodiments of the present invention are also suitable for use in flexible circuits, e.g., flexing circuits for digital cameras and digital camcorders. The signal traces may also be replaced with power traces according to one embodiment.

In the embodiment shown, suspension 290 includes a base-metal layer which can be comprised in part of stainless steel. Suspension 290 further includes a plurality of communication lines 298, each having an end communicatively coupling suspension 290 to the system in which it is implemented, e.g., actuator 121 of hard disk drive 111 of FIG. 1, and an alternative end terminating at a suspension bonding pad, e.g., suspension bonding pads 291-296. Each suspension bonding pad 291-296 provides communicative connectivity with an associated bonding pad of a microactuator, e.g., bonding pads 261-266 of microactuator 260, in an embodiment of the present invention.

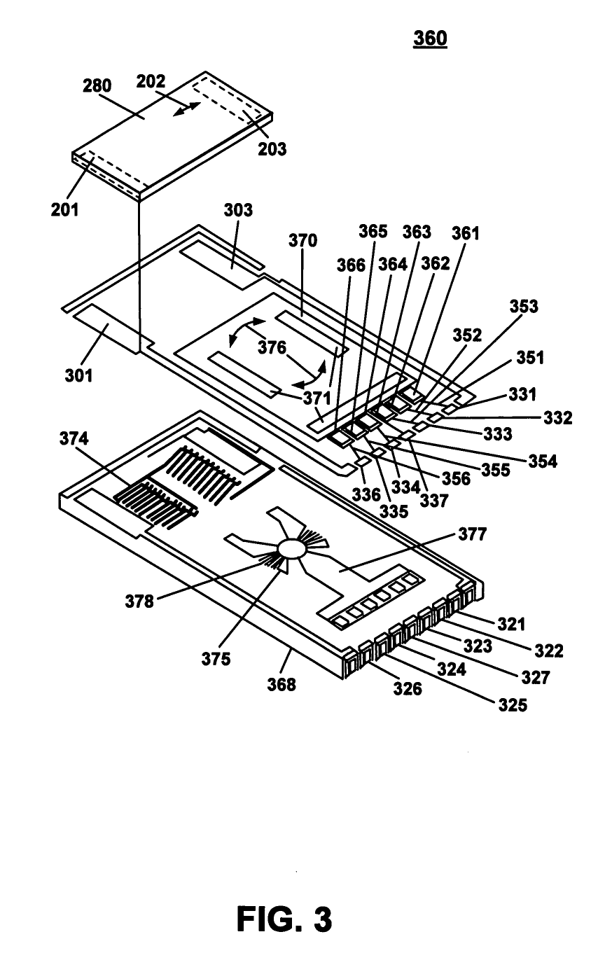

An associated plurality of flexible wires, e.g. flexible wires 351-356 of slider bonding platform 370 of FIG. 3, provide a flexible interconnect between slider bonding pads 261-266 of microactuator 260 and bonding pads 291-296 of suspension 290. In an embodiment of the present invention, pads 261-266 may be separated from bonding platform 370 by a small gap. Although stainless steel is stated herein as the base-metal layer, it is appreciated that alternative metals, and/or combinations thereof, may be utilized as the base-metal layer of suspension 290.

FIG. 3 is an isometric view of the microactuator assembly shown in FIG. 2, e.g., microactuator 260. FIG. 3 shows microactuator assembly 360 to include a substrate 368, a slider bonding platform 370 and a piezoelectric ceramic, e.g., PZT 280 of FIG. 2, in an embodiment of the present invention. Platform 370 is configured to receive thereon, and communicatively couple to, a read/write transducer, e.g. slider 240 of FIG. 2.

A piezoelectric ceramic 280 is shown disposed proximal to slider 240 (when slider 240 is so disposed) and is bonded to platform 370. A PZT ceramic, e.g., PZT 280, can be comprised of Pb—Zr—Ti oxide (lead-zirconium-titanium). Slider bonding platform 370 is shown as interposed between substrate 368 and PZT 280 and slider 240 (when present) and rotates, indicated by arrows 376, relative to the fixed portion of substrate 368.

Microactuator 360 additionally includes a spacer layer 377. Spacer layer 377 is shown disposed on a plurality of locations on substrate 368 of microactuator 360. Spacer layer 377 is approximately between 5 and 20 micrometers thick in the present invention. It is noted that additional descriptions of spacer layer 377 is provided below and may be thicker or thinner than the thickness described herein, may be disposed on alternative locations, and as such, neither measurements nor locations described herein should be construed as a limitation.

Microactuator substrate 368 is shown to include a stroke amplification mechanism 374 and a rotational stage device 375, in which rotational stage device 375 includes rotational springs 378 in the present embodiment. Stroke amplification mechanism 374 and rotational stage device 375 (disposed beneath spacer 377) are fabricated within the structure of substrate 368, such that mechanism 374 and device 377 are integrated within substrate 368 of microactuator 360. Stoke amplification mechanism 374 and rotational stage device 377 and their related functions are more thoroughly described in FIG. 4.

With continued reference to FIG. 3, a plurality of flexible wires 351-356 are coupled to an associated bonding pad 361-366, e.g., microactuator bonding pads 261-266 of FIG. 2. Flexible wires 351-356 provide a flexible communicative coupling of slider platform bonding pads 361-366 to substrate bonding pads 331-336 of substrate 368 which provides a communicative coupling to suspension connectors 321-326 for communicative coupling to suspension bonding pads 291-296 of suspension 290 of FIG. 2. Slider platform 370 is typically fabricated from metal. In an embodiment, slider platform 370 comprises a metal, e.g., copper, that is covered in another metal, e.g., gold. It is noted that in alternative embodiments, alternative metals and combinations thereof may be implemented in slider bonding platform 370.

Slider bonding platform 370 is configured to have a read/write transducer, e.g., slider 240 of FIG. 2, bonded and communicatively coupled thereto. Platform 370 has a plurality of bonding platform spacer pads 377 disposed thereon. The material comprising platform 370 can be non-conductive in an embodiment of the present invention. In an alternative embodiment, the material comprising platform 370 may be conductive with an insulation layer on the surface of substrate 368. In an embodiment of the present invention, platform spacer pads 377 may include adhesive properties. In an alternative embodiment, spacer pads 377 may be fabricated as a combined, single piece with bonding platform 370.

Still referring to FIG. 3, shown is PZT 280 configured to be bonded to PZT bonding pads 301 and 303 and substrate 368 of microactuator 360 in an embodiment of the present invention. PZT 280 has a portion thereof, a fixed portion 201, that is bonded in a fixed position, e.g., fixed position 301, relative to substrate 368, and another portion thereof, e.g., non-fixed portion 203, that is bonded in a non-fixed position, e.g., position 303, to a portion of substrate 368 that is configured for movement there within, in the present embodiment. PZT 280 is configured to have energy, e.g., voltage, flowed there through so as to cause a dimensional change in PZT 280, shown as stroke 202. As voltage is applied, PZT 280 expands or contracts, and by virtue of having a portion of PZT 280 bonded in a fixed position, e.g., fixed position 201, the expansion or contraction of PZT 280, in a length direction and referred to as a stroke, e.g., stroke 202, is amplified, converted into vertical motion, and subsequently transmitted to rotational stage 375.

FIG. 4 is a plan view of a substrate 468 of a microactuator 460, e.g., substrate 268 of microactuator 260 of FIG. 2, in accordance with an embodiment of the present invention. In this embodiment of the invention, a spacer 420 is integrated with the microactuator for providing a gap between the microactuator and a disk drive suspension. In one embodiment of the invention, the spacer 420 is part of the microactuator, however, in other embodiment of the invention, the spacer 420 is part of the suspension or a stand alone device. A description of additional embodiments of an exemplary microactuator spacer is provided below.

Substrate 468, analogous to substrate 268 of FIG. 2, and substrate 368 of FIG. 3, is shown to include a stroke amplifier mechanism 474 and a rotational stage 475 including rotation springs 478 disposed there within. In an embodiment of the present invention, amplifier mechanism 474 and rotational stage 475 are integrated within substrate 468, such that mechanism 474 and stage 475 are incorporated into the structure of substrate 468.

Rotational stage 475 includes rotational springs 478 that provide support for rotational stage 475, in the present embodiment. It is further noted that rotational springs 478 are configured and arranged to provide rotational movement, indicated by arrows 476, while being resistant to other movements, e.g., along x, y, z, roll and pitch axes. As such, rotational springs 478 are fabricated in high-aspect ratio shapes, such that springs 478 are narrow and tall, thus providing rotational movement while being resistant to movement along the above described axes.

In one embodiment of the invention, adhesive 438 is used to couple the microactuator to the suspension. The spacer 420 prevents the adhesive 438 from contacting the moving portions of the microactuator (e.g., rotational portion 478 and stroke amplification portion 474). The spacer 420 forms a dam that ensures that the adhesive 438 only contacts stationary portions of the microactuator.

An etching process that can provide such a high aspect ratio structure, e.g., a silicon deep reactive ion etching (Si-DRIE) process, may be performed on substrate 468 to fabricate mechanism 474 and rotational stage 475 in an embodiment of the present invention. In addition, the etching process can be used to form the spacer 420. By utilizing an Si-DRIE process, rotational springs 478 having dimensions of approximately 5 micrometers wide and approximately 100 microns tall (a high-aspect ratio of 20:1) can be readily fabricated. In another embodiment, alternative etching processes may be implemented provided those alternative processes can provide analogous structures and ratios. In one embodiment of the invention, spacer 420 is formed within the substrate 468, for example, by etching a portion of the substrate 468. In one embodiment of the invention, the spacer 420 is between 5 and 20 microns tall.

Still referring to FIG. 4, while structures having a high aspect ratio are described, e.g., rotational springs 478, in conjunction with the Si-DRIE fabrication process performed on substrate 468 of the present embodiment, it is noted that structures having higher or lower ratios can be fabricated in alternative embodiments.

Substrate 468 also includes a stroke amplifier mechanism 474 disposed within substrate 468. In the present embodiment, a Si-DRIE fabrication process, as described above with reference to rotational springs 478, may be utilized to fabricate stroke amplifier mechanism 474. Mechanism 474 includes a non-tilted amplification bar portion 434 and a tilted amplification bar portion 435 in which the amount of tilt provided therewith is adjustable, in an embodiment of the present invention. The angle of tilt, indicated by angle 436, of tilted amplification bar portion 435 relative to non-tilted amplification bar portion 434 determines the amplification factor provided by stroke amplification mechanism 474. It is noted that by providing angle of tilt adjustability, embodiments of the present invention are well suited for implementation in other electrical systems having alternative specifications and characteristics.

In operation, a voltage is applied to a PZT, e.g., PZT 280 of FIG. 2 whose approximate placement on substrate 468 is indicated by a dashed line 280, causing the non-fixed portion (indicated by variably dashed line) 403 to transfer the contraction or expansion of PZT 280, e.g., stroke 202, along the length of PZT 280 to stroke amplification mechanism 474. The dimensional change contained in stroke 202, received by mechanism 474 from PZT 280, is then converted to vertical motion, indicated by arrows 472. The energy of stroke 202, represented by vertical motion arrow 472, is then transmitted to rotational stage 475 such that rotational springs 478 exert a rotational force, arrows 476, upon that which is disposed thereon.

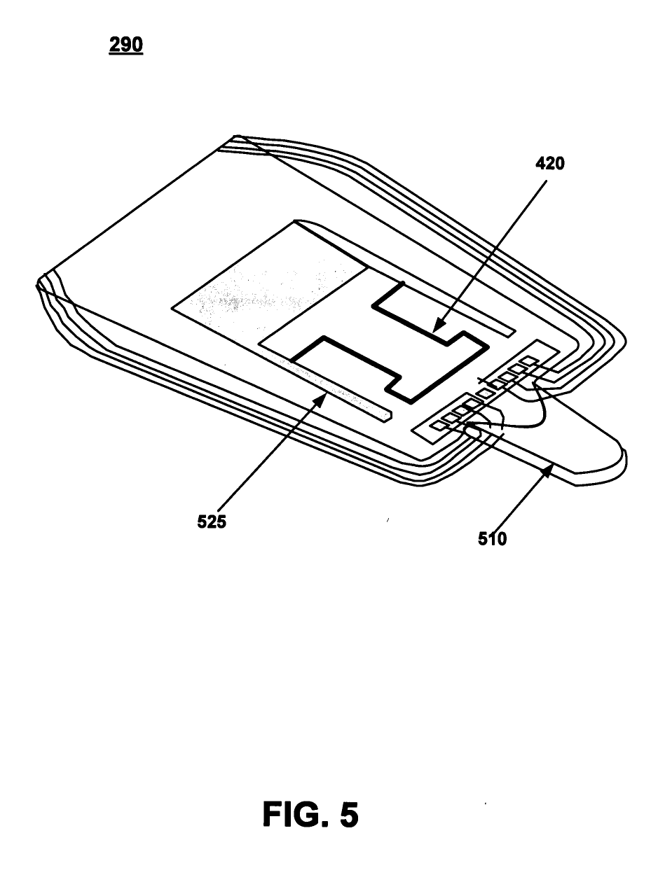

FIG. 5 is an illustration of an exemplary disk drive suspension including an exemplary spacer 420 for maintaining a distance between the suspension 290 and a microactuator in accordance with embodiments of the present invention.

In one embodiment of the invention, a flexure 510 is coupled with a load beam 525. The flexure includes a spacer 420. As stated above, the purpose of the spacer 420 is to maintain a distance between the flexure 510 and the microactuator (260 of FIG. 2). As stated above, the microactuator includes stationary and non-stationary portions. The spacer 420 is used to prevent the moving portion of the microactuator from contacting other parts of the suspension, such as flexure 510. In one embodiment of the invention, the spacer 420 is a stand alone device and may include polyimide material. In other embodiments of the invention, the spacer 420 is formed as part of the microactuator or as part of the flexure 510.

FIG. 5 illustrates a flexure 510 prior to attaching the microactuator. In this embodiment of the invention, spacer 420 can be formed as part of the flexure 510 or can be a stand alone device, for example, a polyimide layer disposed on the flexure 510. In one embodiment of the invention, the spacer 420 is patterned such that it only contacts stationary portions of the microactuator. In one embodiment of the invention, the spacer 420 is less than 25 microns thick and in the range of approximately 5-20 microns in thickness.

It is appreciated that the spacer 420 can be designed according to the microactuator used. As stated above, the spacer 420 should not contact moving parts of the microactuator. In addition, the spacer 420 can be used as a “dam” to prevent adhesive from flowing into the moving portion of the microactuator. Many times adhesive is used to couple the microactuator to the suspension assembly. In this embodiment, the spacer 420 maintains clearance between the moving parts of the microactuator and the suspension, and also prevents adhesive from contacting the moving parts. As an example, the moving parts include the stroke amplification mechanism and rotational portion of the microactuator described above.

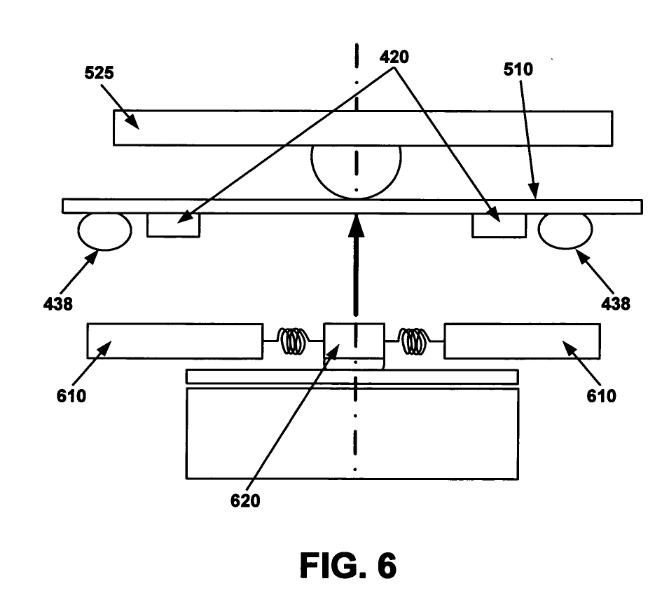

FIG. 6 is a side view of an exemplary disk drive flexure 510, disk drive suspension load beam 525 and spacer 420 prior to bonding in accordance with an embodiment of the present invention. As stated above, the spacer 420 provides a clearance between the flexure 510 and the moving portion 620 of the microactuator. In addition, the spacer 420 prevents adhesive 438 from contacting the moving portion 620 of the microactuator when the parts are bonded. The spacer 420 is formed such that it contacts the stationary portion 610 of the microactuator.

As stated above, the spacer 420 may be a stand alone device that is bonded to both the non-moving portion 610 of the microactuator and the flexure 510. The spacer 420 may also be integral to the flexure 510 or integral to the non-moving portion 610 of the microactuator.

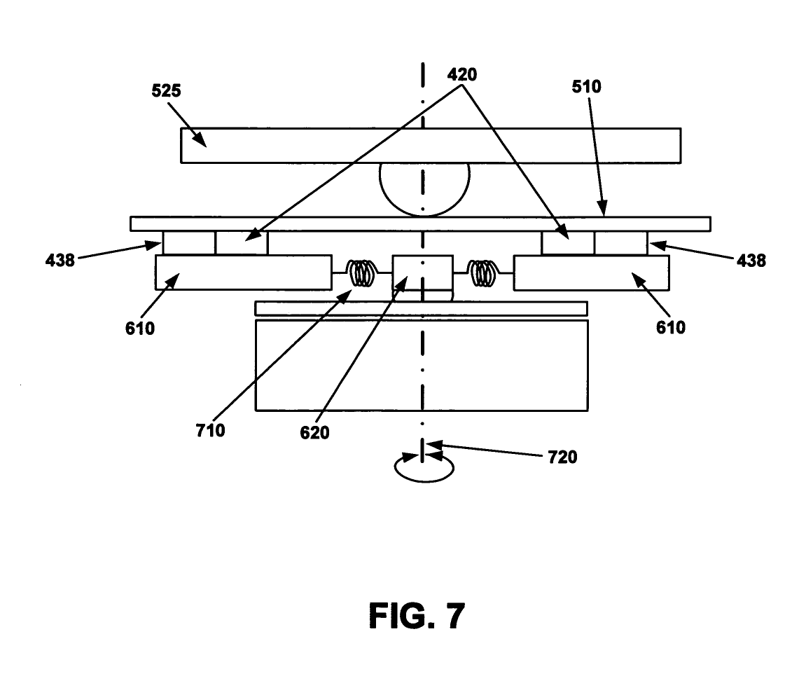

FIG. 7 is a side view of an exemplary disk drive flexure 510, disk drive suspension load beam 525 and spacer 420 after bonding in accordance with an embodiment of the present invention. As shown in FIG. 7, the spacer 420 prevents the adhesive 438 from contacting the moving portion 620 and the spring mechanism 710 of the microactuator. The spacer 420 allows movement 720 of the moving portion 620 while the stationary portion 610 is bonded to the flexure 510.

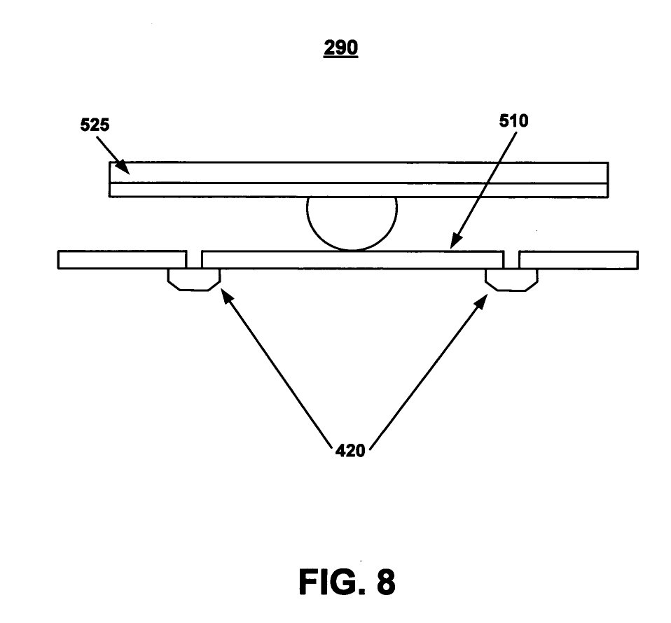

FIG. 8 is a cross section of an exemplary suspension comprising a load beam 525 and a flexure 510 with an integrated spacer 420 in accordance with embodiments of the present invention. As stated above, the spacer can be integral with the flexure 510. In one embodiment of the invention, the flexure 510 is etched to form the spacer 420. However, in another embodiment, the spacers 420 are formed by deforming the flexure. As shown in FIG. 8, the flexure is deformed to form the spacers 420 within the flexure 510.

Embodiments of the present invention, in the various presented embodiments, provide a spacer for maintaining a space between the moving portions of a microactuator and a disk drive suspension. Embodiments of the present invention further provide a spacer as a stand alone device. Embodiments of the present invention also include a spacer integrated with the microactuator and integrated with the suspension flexure.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A disk drive flexure comprising:
a first surface for coupling with a microactuator, said microactuator comprising a moving portion and a stationary portion wherein said moving portion and said stationary portion are integrated within a substrate and wherein said stationary portion is coupled to said first surface by an adhesive; and
a spacer portion for maintaining a distance between said microactuator and said flexure such that said moving portion does not contact said flexure and wherein said spacer portion prevents said adhesive from contacting said moving portion of said microactuator.

2. The disk drive flexure as described in claim 1 wherein said spacer portion comprises polyimide.

3. The disk drive flexure as described in claim 1 wherein said spacer portion is formed within said flexure.

4. The disk drive flexure as described in claim 1 wherein said spacer portion is approximately between 5 and 20 micrometers in height with respect to said first surface.

5. The disk drive flexure as described in claim 1 wherein said spacer portion is formed by etching said first surface.

6. The disk drive flexure as described in claim 1 wherein said spacer portion is positioned proximate a boundary between said stationary portion and said moving portion of said microactuator.

7. A disk drive microactuator comprising:
a substrate having a stationary portion and a non-stationary portion, said substrate having a stroke amplifier and a rotator device integrated within said substrate; and
a spacer portion of said substrate, said spacer portion for maintaining a distance between said microactuator and a suspension coupled with said substrate by an adhesive such that said non-stationary portion does not contact said suspension and such that said spacer portion prevents said adhesive from contacting said non-stationary portion.

8. The disk drive microactuator as described in claim 7 wherein said spacer portion comprises polyimide.

9. The disk drive microactuator as described in claim 7 wherein said spacer portion is formed from said substrate.

10. The disk drive microactuator as described in claim 7 wherein said spacer portion is approximately between 5 and 20 micrometers in height with respect to a surface of said substrate.

11. The disk drive microactuator as described in claim 7 wherein said spacer portion is formed by etching said substrate.

12. The disk drive microactuator as described in claim 7 wherein said spacer portion is positioned proximate a boundary between said stationary portion and said non-stationary portion of said microactuator.

13. A hard disk drive comprising:
a housing;
a disk pack mounted to the housing and having a plurality of disks that are rotatable relative to the housing, the disk pack defining an axis of rotation and a radial direction relative to the axis, and the disk pack having a downstream side wherein air flows away from the disks, and an upstream side wherein air flows toward the disk;
an actuator mounted to the housing and being movable relative to the disk pack, the actuator having one or more heads for reading data from and writing data to the disks; and
an electrical lead suspension, said electrical lead suspension (ELS) having a microactuator coupled thereto by an adhesive, said microactuator having a rotational stage, said microactuator comprising:
a substrate having a stationary portion and a non-stationary portion, said substrate having a stroke amplifier and a rotator device integrated within said substrate; and
a spacer portion of said substrate, said spacer portion disposed proximate a boundary between said stationary portion and said non-stationary portion for maintaining a distance between said microactuator and said electrical lead suspension, such that said non-stationary portion does not contact said electrical lead suspension and such that said adhesive is prevented from contacting said non-stationary portion.

14. The hard disk drive as described in claim 13 wherein said spacer portion of said microactuator comprises polyimide.

15. The hard disk drive as described in claim 13 wherein said spacer portion of said microactuator is formed from said substrate.

16. The hard disk drive as described in claim 13 wherein said spacer portion of said microactuator maintains a distance of approximately between 5 and 20 micrometers between said non-stationary portion of said microactuator and said electrical lead suspension.

17. A hard disk drive comprising:
a housing;
a disk pack mounted to the housing and having a plurality of disks that are rotatable relative to the housing, the disk pack defining an axis of rotation and a radial direction relative to the axis, and the disk pack having a downstream side wherein air flows away from the disks, and an upstream side wherein air flows toward the disk;
an actuator mounted to the housing and being movable relative to the disk pack, the actuator having one or more heads for reading data from and writing data to the disks; and
an electrical lead suspension, said electrical lead suspension (ELS) having a microactuator coupled to a flexure by an adhesive, said flexure comprising:
a first surface for coupling with said microactuator, said microactuator comprising a moving portion and a stationary portion wherein said moving portion and said stationary portion are integrated within a substrate; and
a spacer portion of said first surface, said spacer portion for maintaining a distance between said microactuator and said flexure such that said moving portion does not contact said flexure and such that said adhesive is prevented from contacting said moving portion by said spacer portion.

18. The hard disk drive as described in claim 17 wherein said spacer portion of said flexure comprises polyimide.

19. The hard disk drive as described in claim 17 wherein said spacer portion of said flexure is formed from said flexure.

20. The hard disk drive as described in claim 17 wherein said spacer portion of said flexure maintains a distance of approximately between 5 and 20 micrometers between said non-stationary portion of said microactuator and said flexure.
